(19) United States
(12) Patent Application Publication
(10) Pub. No.: US 2015/0067469 A1
(43) Pub. Date: Mar. 5, 2015

(54) ELECTRONIC APPARATUS AND METHOD FOR DISPLAY CONTROL

(71) Applicant: KABUSHIKI KAISHA TOSHIBA, Tokyo (JP)

(72) Inventor: Eita Shuto, Tokyo (JP)

(73) Assignee: KABUSHIKI KAISHA TOSHIBA, Tokyo (JP)

(21) Appl. No.: 14/163,775

(22) Filed: Jan. 24, 2014

(30) Foreign Application Priority Data
Aug. 30, 2013 (JP) 2013-179523

(51) Int. Cl. G06F 17/24; G06F 17/21

(52) U.S. Cl. CPC G06F 17/241; G06F 17/211
USPC 715/232

(57) ABSTRACT

According to at least one embodiment, an electronic apparatus includes an input module and a display processor. The input module receives data of a document, the document including elements and an annotation, wherein if the document is displayed on a first screen, the elements are arranged in a first layout and the annotation is arranged on at least a part of a first element of the elements. The display processor displays the document on a second screen differing in size from the first screen, using the data, wherein if the document is displayed on the second screen, the elements are arranged in a second layout and the annotation is arranged on at least a part of the first element of the elements in the second layout.

### CROSS-REFERENCE TO RELATED APPLICATIONS

This application is based upon and claims the benefit of priority from Japanese Patent Application No. 2013-179523, filed Aug. 30, 2013, the entire contents of which are incorporated herein by reference.

### FIELD

Embodiments described herein relate generally to an electronic apparatus configured to process documents, and a method for display control applied to the apparatus.

### BACKGROUND

To browse various documents, such as web pages and digital books, various electronic apparatuses, such as desktop or notebook personal computers (PCs), tablet computers, smartphones, and mobile phones, are now being used.

Among the above electronic apparatuses, some have a reflow function of displaying a document in a layout corresponding to a screen size (resolution). If a document is displayed in a layout corresponding to a screen size, users can easily browse the document.

There may be a demand for a function of adding an annotation (annotations) on a currently browsed document. By adding an annotation on a document, users can efficiently utilize the document when they browse it later, or when they let another user browse it.

However, when a user browses a document through an electronic apparatus (such as a smartphone), with an annotation added through another electronic apparatus (such as a notebook PC) of a different screen size, the annotation may be arranged at an unintended position because of the above-mentioned reflow function.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of the appearance of an electronic apparatus according to an embodiment.

FIG. 2 is a block diagram showing the system configuration of the electronic apparatus of the embodiment.

FIG. 3 shows an example in which a layout of elements of a document is changed (reflowed) by the electronic apparatus of the embodiment.

FIG. 4 shows an example in which an annotation added on a document is displayed in an inappropriate area after layout change.

FIG. 5 shows an example in which an annotation added on a document is displayed in an appropriate area by the electronic apparatus of the embodiment after layout change.

FIG. 6 is a block diagram showing the functional structure of a browser application program executed by the electronic apparatus of the embodiment.

FIG. 7 is a view for explaining an example of a determination made by the electronic apparatus of the embodiment to determine the reference element corresponding to an annotation.

FIG. 8 shows a configuration example of element data used by the electronic apparatus of the embodiment.

FIG. 9 shows a configuration example of annotation data used by the electronic apparatus of the embodiment.

FIG. 10 shows an example an annotation scaled by the electronic apparatus of the embodiment in accordance with scaling of a reference element.

FIG. 11 shows another example in which an annotation added on a document is displayed in an appropriate area after a layout change by the electronic apparatus of the embodiment.

FIG. 12 shows yet another example in which an annotation handwritten on a document is displayed in an appropriate area after a layout change by the electronic apparatus of the embodiment.

FIG. 13 is a flowchart showing an example of the procedure of document storage processing executed by the electronic apparatus of the embodiment.

FIG. 14 is a flowchart showing an example of the procedure of document display processing executed by the electronic apparatus of the embodiment.

### DETAILED DESCRIPTION

Various embodiments will be described hereinafter with reference to the accompanying drawings.

In general, according to one embodiment, an electronic apparatus includes an input module and a display processor. The input module is configured to receive input data of a document, the document including a plurality of elements and an annotation, wherein if the document is displayed on a first screen, the plurality of elements are arranged in a first layout and the annotation is arranged on at least a part of a first element of the plurality of elements. The display processor is configured to display the document on a second screen differing in size from the first screen, using the input data, wherein if the document is displayed on the second screen, the plurality of elements are arranged in a second layout and the annotation is arranged on at least a part of the first element of the plurality of elements in the second layout.

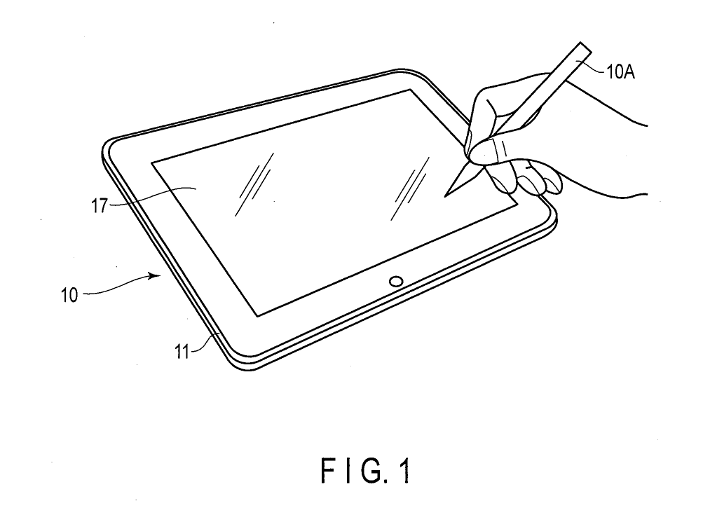

FIG. 1 is a perspective view of the appearance of an electronic apparatus according to an embodiment. This electronic apparatus can be realized as a tablet computer, a notebook personal computer 10 computer, a smartphone, a PDA, etc. In the description below, the electronic apparatus is realized as a tablet computer 10. The tablet computer 10 is a mobile electronic apparatus also called a tablet or a slate computer. As shown in FIG. 1, the tablet computer 10 includes a main unit 11 and a touch screen display 17. The touch screen display 17 is attached to the main unit 11, superposed on the upper surface of the main unit 11.

The main unit 11 has a thin box-shaped housing. The touch screen display 17 incorporates a flat panel display, and a sensor configured to detect the contact position of a pen or finger on the screen of the flat panel display. The flat panel display may be, for example, a liquid crystal display (LCD). As the sensor, a capacitance type touch panel, an electromagnetic induction type digitizer, etc., can be used. In the description below, it is supposed that the touch screen display 17 incorporates two types of sensors, i.e., the digitizer and the touch panel.

The digitizer and the touch panel are each superposed on the screen of the flat panel display. The touch screen display 17 can detect not only a touch operation on the screen using a finger, but also a touch operation on the screen using a pen 10A. The pen 10A may be, for example, an electromagnetic induction pen. Using the pen 10A or finger, the user can perform various gesture operations, such as tapping, dragging, swiping, clicking, etc., on the touch screen display 17.

Further, the user can perform a handwriting input operation on the touch screen display 17 using the pen 10A. During the handwriting input operation, the locus of the movement of the pen 10A on the screen, i.e., the stroke of handwriting, is drawn in real time, whereby a plurality of handwriting strokes (the loci of the handwriting strokes) are displayed on the screen.

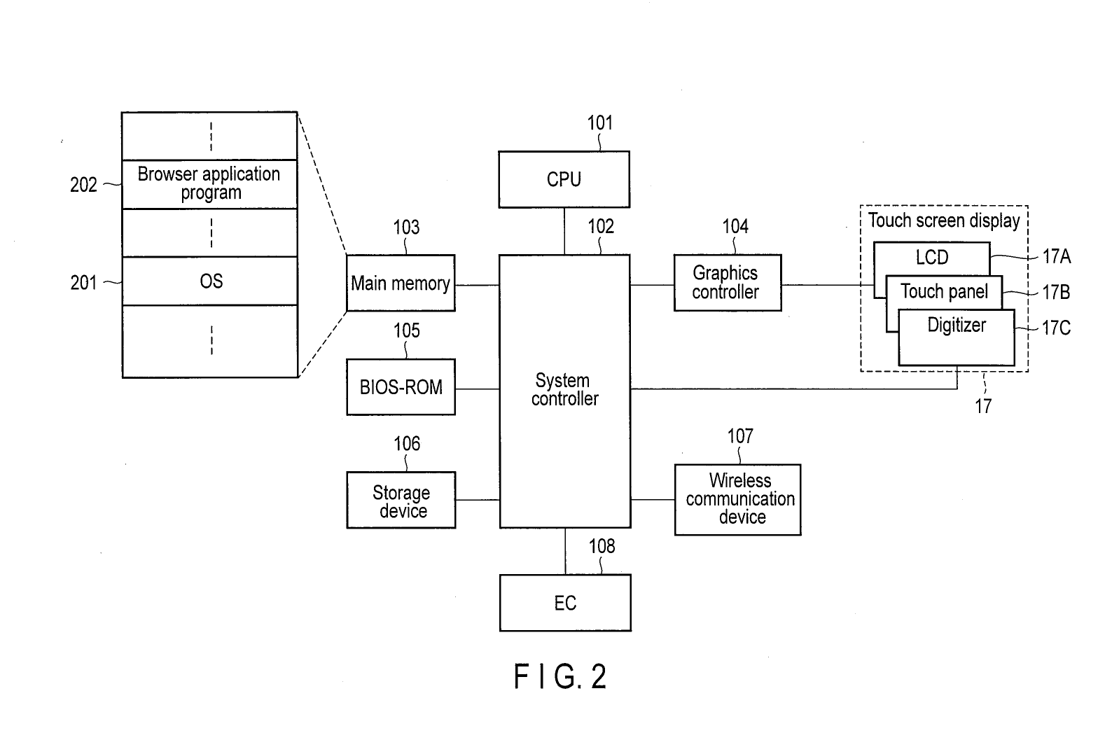

FIG. 2 a block diagram showing the system configuration of the tablet computer 10 according to the embodiment.

As shown in FIG. 2, the tablet computer 10 includes a CPU 101, a system controller 102, a main memory 103, a graphics controller 104, a BIOS-ROM 105, a storage device 106, a wireless communication device 107, an embedded controller (EC) 108, etc.

The CPU 101 is a processor configured to control various components incorporated in the tablet computer 10. The CPU 101 executes various programs loaded from the storage device 106 to the main memory 103. The programs executed by the CPU 101 include an operating system (OS) 201 and various application programs such as a browser application program 202. The browser application program 202 has a function of receiving data of document (such as web page) from a server, a function of displaying the document on the screen, a function of adding an annotation on the document, and a function of storing the document.

The CPU 101 also executes a basic input output system (BIOS) stored in the BIOS-ROM 105. The BIOS is a program for hardware control.

The system controller 102 is a device configured to connect between the local bus of the CPU 101 and respective components. The system controller 102 includes a memory controller configured to control access to the main memory 103, and has a function of communicating with the graphics controller 104 via, for example, a serial bus.

The graphics controller 104 is a display controller configured to control an LCD 17A used as the display monitor of the tablet computer 10. The display signal generated by the graphics controller 104 is sent to the LCD 17A. The LCD 17A displays a screen image based on the display signal. A touch panel 17B configured to detect the touch position of a finger on the screen is provided on the upper surface of the LCD 17A. Further, a digitizer 17C configured to detect the touch position of the pen 10A on the screen is provided on the lower surface of the LCD. The touch panel 17B is a capacitance type pointing device for performing input operations on the screen of the LCD 17A. The touch panel 17B detects, for example, the touch position of a finger on the screen, and a motion of the touch position of the finger. The digitizer 17C is an electromagnetic induction type pointing device for performing input operations on the screen of the LCD 17A. The digitizer 17C detects, for example, the touch position of the pen 10A on the screen, and a motion of the touch position of the pen 10A.

The OS 201 issues an input event indicating that a finger has touched the screen, and indicating the touch position of the finger, by cooperating with a driver program configured to control the touch panel 17B. The OS 201 also issues an input event indicating that the pen 10A has touched the screen, and indicating the touch position of the pen 10A, by cooperating with a driver program configured to control the digitizer 17C.

The wireless communication device 107 is configured to execute wireless communication, such as wireless LAN communication or 3G mobile communication.

The EC 108 is a one-chip microcomputer including an embedded controller for power management, and has a function of turning on and off the tablet computer 10 in accordance with operation of a power button by the user.

As described above, the browser application program 202 has a browsing function of displaying a document on the screen. It is sufficient if the document contains at least a text, an image, a table, a figure, and/or the like. For instance, the document is a web page of an HTML format an electronic book of an ePub format. The document includes, for example, a plurality of elements (blocks) having a tree structure.

The browser application program 202 also has a reflow function of determining, when displaying a document such as a web page of an HTML format, the layout of elements in accordance with the size of the screen, the tree structure of the elements in the web page, the font size, etc. The screen size may indicate the resolution instead of the physical size of the screen. Further, since the orientation of the screen (assumed when the electronic apparatus is located in front of the user) can be changed by, for example, rotating the display, the browser application program 202 treats the screen as having different sizes when the screen is in a landscape mode and in a portrait mode. Accordingly, when using the reflow function, the browser application program 202 can change the layout of the elements depending upon whether the screen is in the landscape mode or the portrait mode.

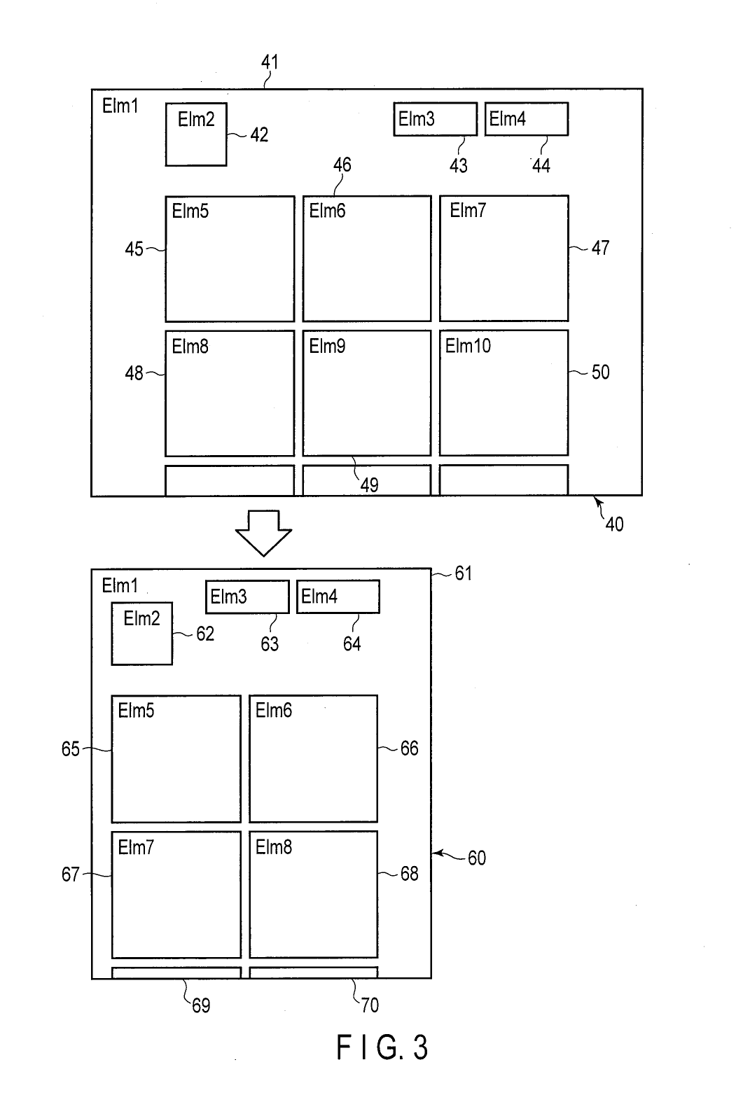

Referring now to FIG. 3, a description will be given of a document example displayed using the reflow function.

The browser application program 202 changes the layout of the elements in a document (web page) in accordance with, for example, the screen size, i.e., reflows the elements in the document. For instance, the same document is displayed with different layouts between the large screen of a notebook PC and the small screen of a tablet computer or a smartphone.

FIG. 3 shows that a first screen 40 and a second screen 60 display the same document (e.g., a web page based on the same HTML source code). However, since the first and second screens 40 and 60 have different sizes, they differ in the layout of the elements in the document.

For instance, although “Element 1 (Elm1)” 61 to “Element 8 (Elm8)” 68 in the document on the second screen 60 correspond to “Element 1 (Elm1)” 41 to “Element 8 (Elm8)” 48 in the document on the first screen 40, respectively. The layout of the elements is changed between the first and second screens 40 and 60 because the width of the second screen 60 is narrower than that of the first screen 40. Further, regarding “Element 9 (Elm9)” 49 and “Element 10 (Elm10)” 50 in the document on the first screen 40, the second screen 60 shows only parts of elements 69 and 70 corresponding to the elements 49 and 50. If, for example, the second screen 60 is scrolled, the entire elements 69 and 70 are displayed.

Thus, the browser application program 202 can display a document with a layout corresponding to the screen size of the display 17.

There may be a demand for user's additionally making an arbitrary description, such as an annotation, comments, a memorandum, on a document (web page). If an annotation, etc., is added to a document, the document can be efficiently utilized when, for example, the user browses the document later, or when the user allows another user to browse the document.

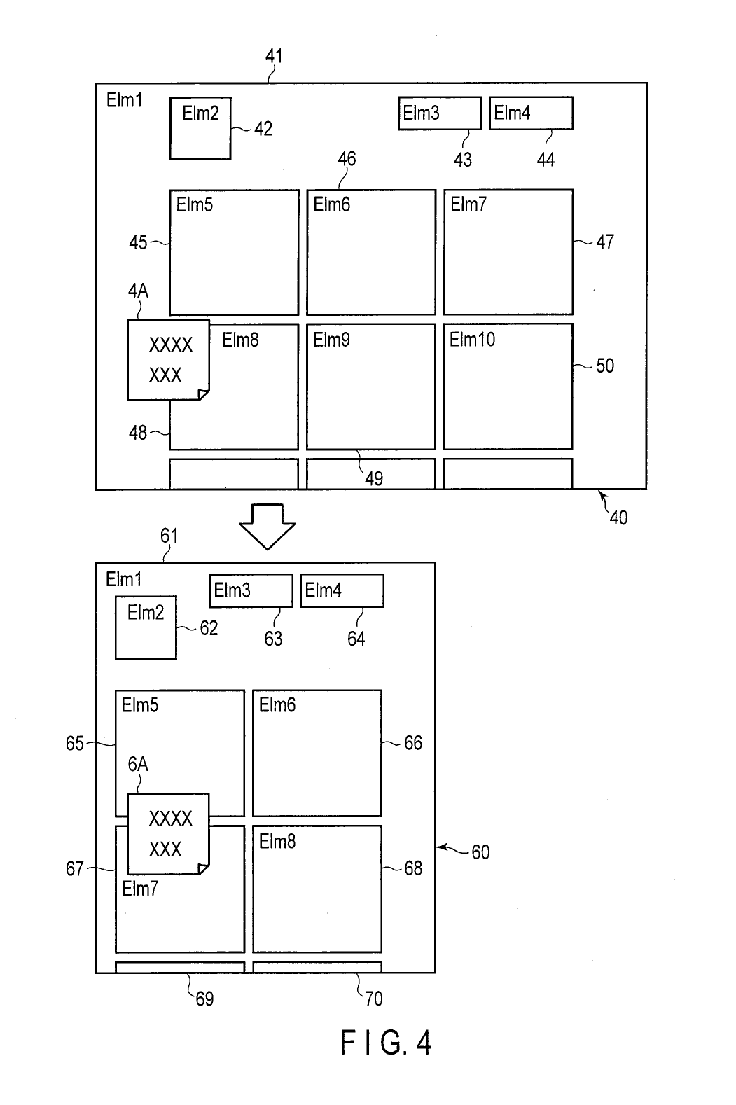

In the example shown in FIG. 4, an annotation 4A is added to “Element 8 (Elm8)” 48 displayed on the first screen 40. As mentioned above, the elements in the document are reflowed in accordance with the screen size. Therefore, “Element 8 (Elm8)” 48 on the first screen 40 corresponds to “Element 8 (Elm8)” 68 on the second screen 60 which has a size different from the first screen 40.

However, if the annotation 4A, which is superimposed on “Element 8 (Elm8)” 48 on the first screen, is positioned at the same coordinates on the second screen 60 as those on the first screen 40, it will be superimposed on “Element 5 (Elm5)” 65 and “Element 7 (Elm7)” 67 on the second screen 60. Thus, if the layout of the elements is changed by the reflow of the elements based on the screen size, the annotation 4A may be superimposed onto an element (or elements) that the user does not intend.

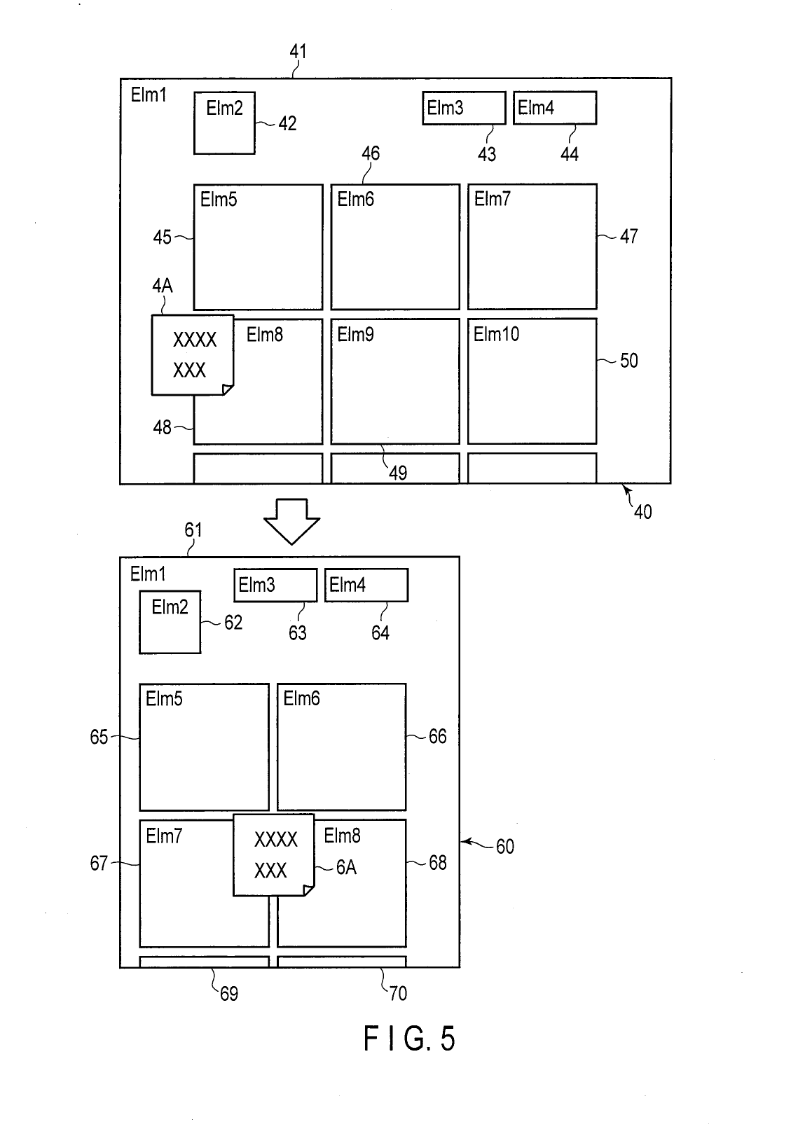

In the embodiment, as shown in FIG. 5, an annotation on a document is appropriately arranged according to a reflow of elements in the document. More specifically, in the embodiment, if a document with an annotation displayed on a first-size screen of a computer is displayed on a second-size screen of another computer and the second size is different from the first size, the positional relationship between the annotation and an element corresponding to the annotation (i.e., a reference element linked to the annotation) is maintained between the two screens.

In the example shown in FIG. 5, the annotation 4A is superimposed on at least part of “Element 8 (Elm8)” 48 on the first screen 40. In addition, on the second screen 60, which has a size different from the size of the first screen 40, the elements in the document that are reflowed are displayed. On the second screen 60, an annotation 6A is superimposed on at least part of “Element 8 (Elm8)” 68 corresponding to “Element 8 (Elm8)” 48. That is, the positional relationship between the annotation and the element corresponding to the annotation is maintained. Consequently, even if the elements are reflowed, the annotation is moved, linked with the user's intended element, and hence the necessary parts (which the user wishes not to hide by the annotation) of the original document can be made not to be superimposed by the annotation.

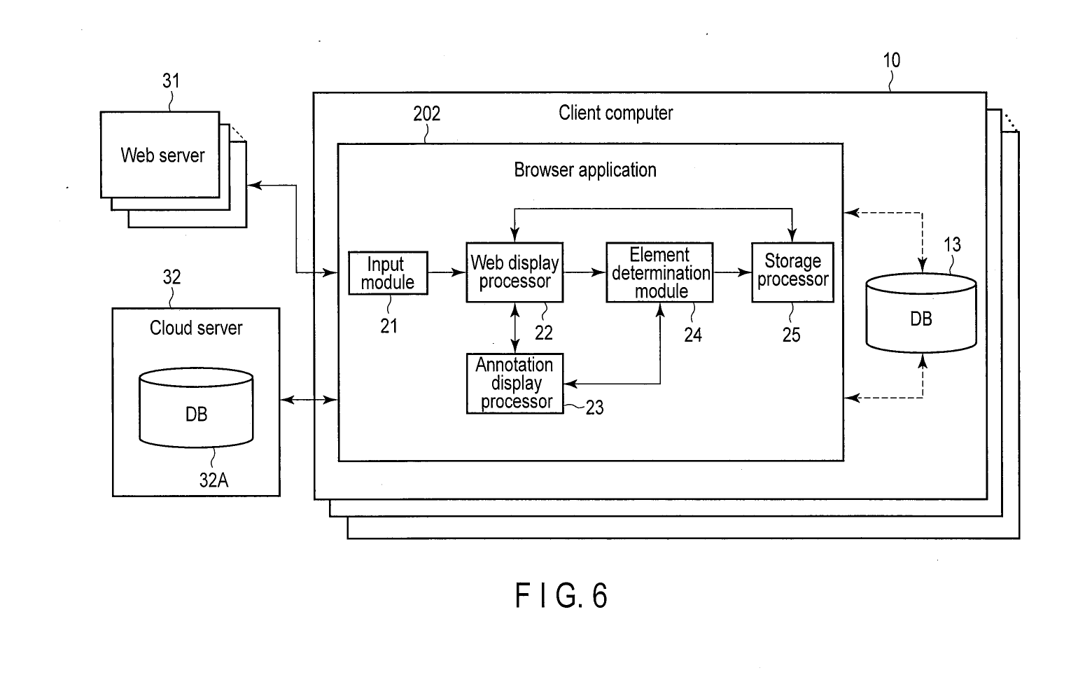

FIG. 6 shows a functional configuration example of the browser application program 202 executed by the electronic apparatus of the embodiment. The browser application program 202 displays a document on the screen using document data sent from a web server 31 or a cloud server 32. The electronic apparatus of the embodiment will hereinafter also be referred to as “the client computer 10.” The client computer 10 can be realized as various electronic apparatuses, such as a tablet computer, a notebook PC, a smartphone and PDA.

The browser application program 202 includes, for example, an input module 21, a web display processor 22, an annotation display processor 23, an element determination module 24, and a storage processor 25. Processing of adding an annotation to a displayed document (web page) and storing the annotated document, and processing of displaying the stored document on the screen by the browser application program 202 will now be described sequentially.

Firstly, a description will be given of a case where the browser application program 202 adds an annotation to a displayed document and stores the annotated document.

The input module 21 receives document data (input document data) from the web server 31. To facilitate the description, it is assumed that the document is a web page. The input module 21 requests the web server 31 to send data of the web page of a designated URL in accordance with, for example, the user's operation, and receives the web page data sent by the web server 31. The web page data includes, for example, an HTML source code.

The web display processor 22 subjects, to document object model (DOM) analysis, the HTML source code included in the received web page data, to thereby detect elements (of a tree structure) included in the web page. Subsequently, the web display processor 22 determines a first layout on a first screen that displays the detected elements. More specifically, the web display processor 22 determines the size and display position of each element, based on the size of the first screen (or the size of a window), the content of the text or image(s) in each element, the font size of the text, the relationship between the elements (e.g., the inclusive relation between the elements), parameters associated with the elements, etc. The web display processor 22 displays, on the first screen, a web page including a plurality of elements arranged based on the determined first layout.

The annotation display processor 23 makes an annotation on the displayed web page in accordance with the user's operation. For instance, the annotation display processor 23 displays an image indicating an area of an annotation (e.g., an image indicating a sticky note) at an arbitrary position on the web page in accordance with the user's operation for making an annotation. After that, the annotation display processor 23 displays, within the image, characters (text) corresponding to the user's input operation using the keyboard. Alternatively, the annotation display processor 23 may display, on the web page, an annotation including handwritten characters or figures (handwriting strokes) in accordance with the user's handwriting input operation using the touch screen display 17.

When storage of the currently displayed web page (document) has been requested, the element determination module 24 determines the element (reference element) corresponding to the annotation on the web page. The reference element is selected from a plurality of elements arranged in the first layout in accordance with a relevance degree of each element to the annotation.

More specifically, the element determination module 24 calculates the evaluated value V of each of one or more elements contained in the web page. The evaluated value V indicates the degree to which the element is relevant to the annotation. For instance, the evaluated value V is determined using a ratio of an overlapping portion between the region of a first element and the region of the annotation to the region of the annotation. Specifically, the element determination module 24 calculates the overlapping portion (the planar dimension of the overlapping portion) E∩A between each element region E and annotation region A, i.e., the superimposed areas of the regions E and A. Further, the element determination module 24 calculates the evaluated value V based on the ratio (hereinafter also referred to “the first ratio”) of the overlapping portion E∩A to the annotation region (area) A, and the ratio (hereinafter also referred to “the second ratio”) of the overlapping portion E∩A to the element region (area) E.

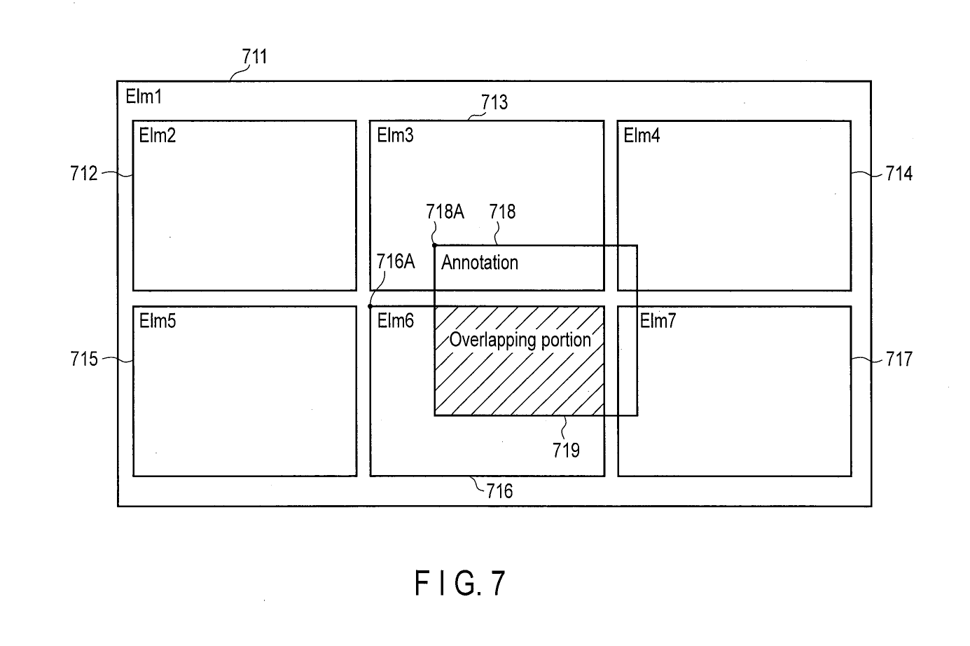

Referring now to FIG. 7, a description will be given of an example of determining a reference element corresponding to an annotation. In the example of FIG. 7, it is assumed that one annotation 718 is added to a document including a plurality of elements 711 to 717 arranged in the first layout.

The annotation display processor 23 calculates the evaluated value V that indicates the relevance of each of the elements 711 to 717 to the annotation 718. The evaluated value V is calculated based on the ratio (first ratio) of the overlapping portion E∩A between the region A of the annotation 718 and the region E of each element to the region A of the annotation 718, and the ratio (second ratio) of the overlapping portion E∩A between the region A of the annotation 718 and the region E of each element to the region E of said each element. For instance, the evaluated value V is calculated using the following equation:

V=(E∩A/A)α×(E∩A/E)β

where α and β are parameters for weighting the first and second ratios, respectively. Alternatively, the evaluated value V may be obtained by weighting addition of the first and second ratios.

More specifically, a description will be given of the evaluated values associated with “Element 1 (Elm1)” 711 and “Element 6 (Elm 6)” 716 shown in FIG. 7.

In the case of “Element 1” 711, the ratio (first ratio) of the overlapping portion E1∩A between the region A of the annotation 718 and the region E1 of the element 711 to the region A of the annotation 718 is maximum among all elements 711 to 717. Namely, since in the case of “Element 1” 711 including the entire annotation 718, E1∩A=A, the first ratio is maximum (E1∩A/A=1). However, in the case of “Element 1” 711, the ratio E1∩A/E1 (second ratio) of the overlapping portion E1∩A between the region A of the annotation 718 and the region E1 of the element 711 to the element region E1 is small.

In contrast, in the case of “Element 6” 716, the ratio (first ratio) of the overlapping portion E6∩A between the region A of the annotation 718 and the region E6 of the element 716 to the region A of the annotation 718 is second maximum among all elements 711 to 717. In addition, in the case of “Element 6” 716, the ratio E6∩A/E6 (second ratio) of the overlapping portion E6∩A between the region A of the annotation 718 and the region E6 of the element 716 to the element region E6 is maximum among all elements 711 to 717.

Since the evaluated value V is calculated based on the first and second ratios, the evaluated value V of “Element 6” 716 is maximum among all elements 711 to 717.

The element determination module 24 determines the element with a maximum evaluated value V as being the reference element corresponding to the annotation. In the example of FIG. 7, based on the calculated evaluated values V of the elements 711 to 717, the element determination module 24 determines “Element 6” 716 with the maximum evaluated value V as being the reference element corresponding to the annotation 718. Namely, the element determination module 24 determines that the element with the maximum evaluated value is the element the user intends to link to the annotation. Subsequently, the element determination module 24 calculates the relative coordinates (relative position) of the annotation 781 to a reference element 716 arranged in the first layout. These relative coordinates are represented by, for example, the coordinates 718A of the upper left corner of the annotation 718, assuming that the coordinates 716A of the upper left corner of the reference element 716 are the coordinates of the origin.

If a plurality of annotations exist on a displayed document, the element determination module 24 determines reference elements corresponding to these annotations, and then calculates relative coordinates corresponding to the determined reference elements.

The storage processor 25 stores document data corresponding to a document which includes, if the document is displayed on the first screen, a plurality of elements arranged in the first layout and an annotation provided on at least a part of a first element (reference element) of the elements. More specifically, the storage processor 25 stores document data that includes data (HTML source code) of web page, element data corresponding to elements in the web page, and annotation data corresponding to an annotation on the web page. The document data can be stored in an arbitrary storage medium. For instance, the document data is stored in a DB 13 provided in the client computer 10, or in a DB 32A provided in the cloud server 32.

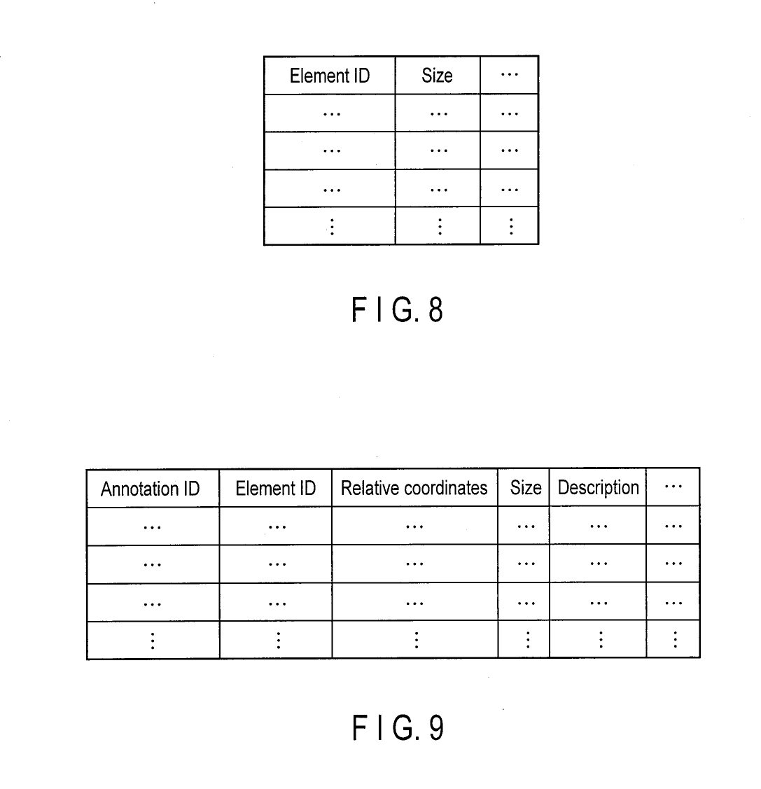

FIG. 8 shows a configuration example of element data. The element data includes, for example, a plurality of entries corresponding to a plurality of elements in a document (e.g., a web page and an electronic book). Each entry includes element ID, size, etc.

In the entry corresponding to a certain element, “Element ID” indicates identification information assigned to the element. “Size” indicates the size in which the element is displayed on the screen. “Size” indicates, for example, the width and height of a rectangular region in which the element is displayed.

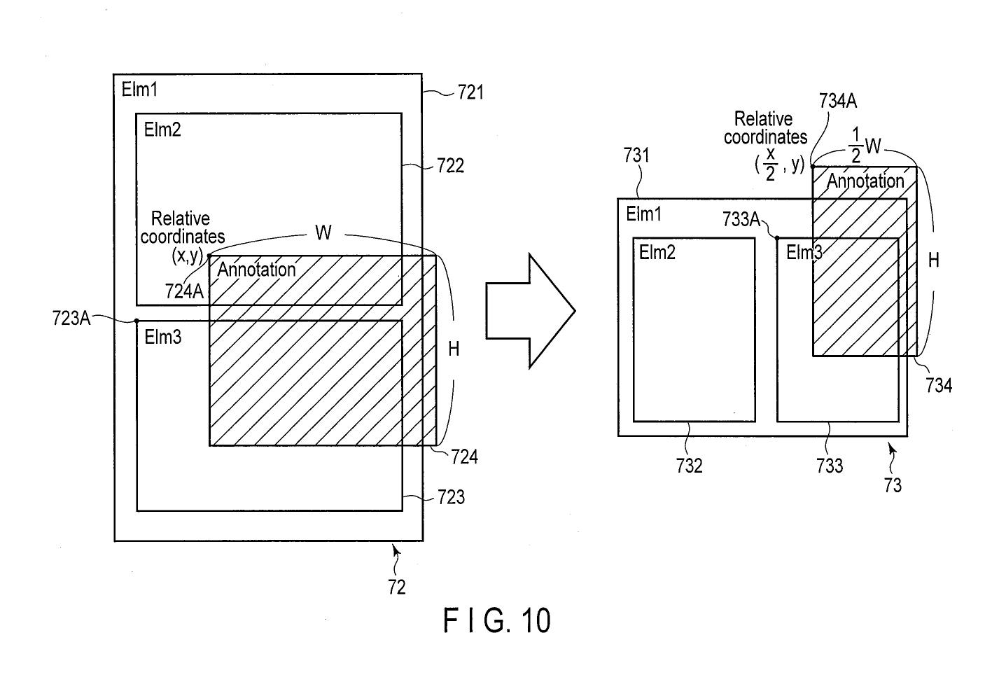

FIG. 9 shows a configuration example of annotation data. The annotation data includes, for example, one or more entries corresponding to one or more annotations made on a document. Each entry includes annotation ID, element ID, relative coordinates, size, description, etc.

In the entry corresponding to a certain annotation, “Annotation ID” indicates identification information assigned to the annotation. “Element ID” indicates identification information assigned to the reference element corresponding to the annotation. As the “Element ID,” element ID corresponding to an element of the elements indicated by the above-mentioned element data is set. “Relative coordinates” indicate the relative coordinates (relative position) of the annotation relative to the reference element. “Size” indicates, for example, the width and height of a rectangular region in which the annotation is displayed. “Description” indicates the description of the annotation, and is, for example, a text written as the annotation.

If there is no annotation on a displayed web page, the storage processor 25 stores document data including data (HTML source code) of the web page.

Storing the document data as described above enables the stored document to be browsed again or to be browsed by a client computer 10 other than the client computer 10 storing the document.

A description will then be given of the processing of displaying the stored document on the screen performed by the browser application program 202. The client computer 10 that stores a document may differ from the client computer 10 that displays the stored document. For instance, the user browses a document on a first client computer 10 (such as a notebook PC) having a first screen, and stores the document with an annotation attached thereto. After that, the user can acquire the stored document data by a second client computer 10 (such as a smartphone) having a second screen, and browse the document with the annotation, which is added by the first client computer 10, displayed on the second screen. The browser application program 202 displays the stored document in accordance with, for example, the screen size of the client computer 10 in which the program 202 is executed.

More specifically, firstly, the input module 21 inputs document data stored in a storage medium. The input module 21 may receive the document data from, for example, the DB 32A in the cloud server 32, or may read it from the DB 13 of the client computer 10. The input module 21 receives document data that indicates, for example, a document that includes, if the document is displayed on the first screen, a plurality of elements arranged in the first layout and an annotation provided on at least a part of a first element (reference element) of these elements.

If displaying a document on a second screen differing in size from the first screen, using the input document data, the web display processor 22 and the annotation display processor 23 display, on the second screen, a document that includes a plurality of elements arranged in a second layout and an annotation arranged on at least a part of a first element (a reference element corresponding to the reference element on the first screen).

More specifically, as in the case of receiving web page data from the web server 31, the web display processor 22 subjects the HTML data in the document data to DOM analysis, to thereby detect elements (the tree structure of the elements) included in the web page (document). After that, the web display processor 22 determines a second layout on the second screen on which the detected elements are displayed. For instance, the web display processor 22 determines the display position and size of each element on the second screen, based on the size of the second screen (or the size of a window), the content of the text or image(s) included in each element, the font size of the text, the relationship between the elements (e.g., the inclusive relationship between the elements), parameters associated with the elements, etc.

The annotation display processor 23 detects a reference element corresponding to the annotation on the web page, using the annotation data in the document data. After that, the annotation display processor 23 compares the size of the reference element (i.e., the size of the reference element on the first screen) indicated by the element data in the document data, with the size of the current reference element (i.e., the size of the reference element on the second screen) calculated by the web display processor 22, thereby determining whether the size of the reference element has been changed.

If the reference element size has not been changed, the web display processor 22 and the annotation display processor 23 display the document with the annotation on the second screen. The annotation is arranged at a position relative to the reference element in the second layout, the position being determined based on a position of the annotation relative to the reference element (first element) in the first layout.

More specifically, if the size of the reference element has not been changed, the annotation display processor 23 calculates the position on the second screen, at which the annotation is to be displayed, based on the position of the reference element calculated by the web display processor 22, and the relative coordinates, indicated by the annotation data, of the annotation relative to the reference element (i.e., the coordinates of the annotation relative to the reference element arranged in the first layout on the first screen). Namely, the annotation display processor 23 determines, as being the display position of the annotation on the second screen, the position having relative coordinates, which are indicated by the annotation data, relative to the reference element arranged in the second layout. Thus, the web display processor 22 and the annotation display processor 23 display a document on the second screen. The document includes the element that is arranged at the position in the size calculated by the web display processor 22. The document also includes the annotation that is arranged at the position calculated by the annotation display processor 23 and has the size indicated by the annotation data (i.e., the size in which the annotation was displayed when the web page was stored).

As a result, as in the aforementioned example of FIG. 5, even if the positions of the elements in a document have been changed (reflowed), an annotation can be displayed at an appropriate position. Namely, if the positions of the elements in a document have been changed (reflowed) as in the change from the element layout on the first screen 40 to the element layout on the second screen 60, the annotation 6A corresponding to the annotation 4A on the first screen 40 can be displayed at an appropriate position on the second screen 60.

In contrast, if the size of the reference element has been changed, i.e., if the size of the reference element (first element) in the second layout differs from the size of the reference element in the first layout, the web display processor 22 and the annotation display processor 23 display, on the second screen, a document including an annotation that has the size determined from the relationship between the size of the reference element in the first layout and the size of the reference element in the second layout.

More specifically, if the size of the reference element has been changed, the annotation display processor 23 displays, on the second screen, a document that includes an annotation having a size corresponding to a change in the size of the reference element. The annotation display processor 23 calculates the size of the region on the screen used to display the annotation, based on a change in the size of the reference element (suppose, for example, that the size is doubled), and the size of the annotation indicated by the annotation data. Namely, the annotation region is scaled. The annotation display processor 23 also calculates the position on the second screen at which the annotation is to be displayed, based on the position of the reference element calculated by the web display processor 22, the change in the size of the reference element, and the relative coordinates, indicated by the annotation data, of the annotation relative to the reference element. More specifically, the annotation display processor 23 shifts the relative coordinates of the annotation relative to the reference element, indicated by the annotation data, in proportion to a change in the size of the reference element (e.g., the reference element size is doubled). The annotation display processor 23 then adds the shifted relative coordinates to the coordinates of the position of the reference element calculated by the web display processor 22, thereby calculating the position of the annotation on the second screen. After that, the web display processor 22 and the annotation display processor 23 display, on the second screen, a document that includes a plurality of elements arranged at the positions in the sizes calculated by the web display processor 22, and an annotation arranged at the position in the size calculated by the annotation display processor 23.

As described above, the web display processor 22 may change not only the display position of elements in a document, but also the size of each element (scaling), during reflowing. In such a case, the annotation display processor 23 determines the position and size of the annotation in view of a change in the position and size of each element.

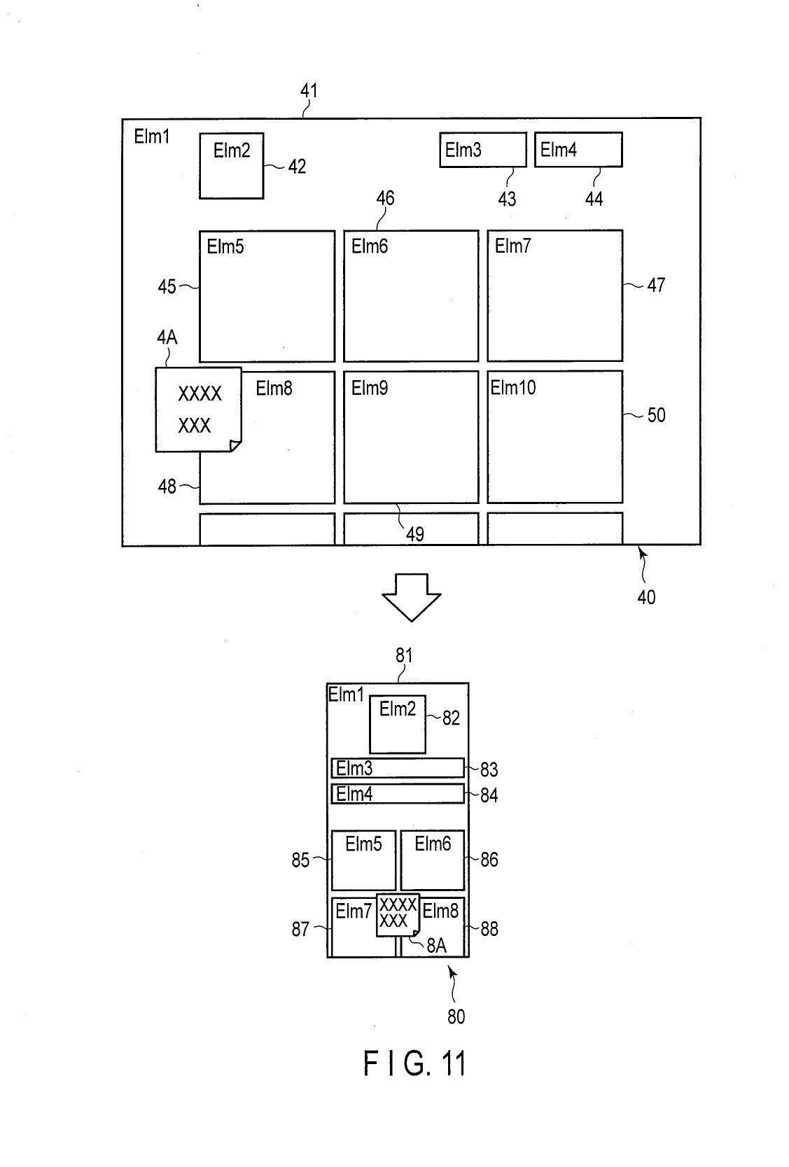

Referring then to FIG. 10, a description will be given of a case where the position and size of an annotation are determined in accordance with changes (reflows) in the position and size of each element. Assume here that the document displayed on a first screen 72 includes elements 721 to 723, and an annotation 724 is added on at least a part of the element 721, 722, 723. Further, assume that the element determination module 24 has already determined that the reference element corresponding to the annotation 724 is “Element 3 (Elm3)” 723.

If the document on the first screen 72 is displayed on a second screen 73 differing in size from the first screen 72, the web display processor 22 determines a layout for displaying elements 731 to 733 corresponding to the elements 721 to 723 on the second screen 73. The web display processor 22 determines the positions and sizes of the elements 731 to 733 in accordance with the size of the second screen 73.

Since the size of the reference element (“Element 3”) 723 displayed on the first screen 72 differs from that of the reference element (“Element 3”) 733 determined by the web display processor 22, the annotation display processor 23 determines the size of an annotation 734 in accordance with the size change of the reference element. Note that the size change is not limited to scaling (enlargement/reduction) in which the aspect ratio of the reference element is maintained, but may be scaling in which the aspect ratio is not maintained such as only the horizontal or vertical scaling.

The annotation display processor 23 also determines the position of the annotation 734 in accordance with a change in the size of the reference element. More specifically, the annotation display processor 23 determines the position of the annotation 734 based on the coordinates of the annotation 724 relative to the reference element 723 on the first screen 72, and the position of the reference element 733 on the second screen 73.

In the example of FIG. 10, the annotation display processor 23 detects that the size change from the reference element 723 on the first screen 72 to the reference element 733 on the second screen 73 is ½ scale-down of the horizontal size (width). Based on the detected size change, the annotation display processor 23 determines the width (W/2) of the annotation 734 on the second screen 73 by multiplying the width W of the annotation 724 by ½. In this case, since the size change is only a horizontal scale-down, the height H of the annotation 734 on the second screen 73 is equal to that of the annotation 724 on the first screen 72.

Further, since the size change of the reference element is a ½ scale-down of the horizontal size of the element, and the coordinates (x, y) of the upper left corner 724A of the annotation 724 on the first screen 72 are determined using, as the origin, the coordinates 723A of the upper left corner of the reference element 723 on the first screen 72, the annotation display processor 23 calculates the coordinates (x/2, y) of the upper left corner 734A of the reference element 734 on the second screen 73, which are obtained when the coordinates 733A of the upper left corner of the reference element 733 on the second screen 73 is used as the origin. Subsequently, the annotation display processor 23 adds the relative coordinates (x/2, y) of the annotation 734 to the coordinates 733A of the upper left corner of the reference element 733 on the second screen 73, thereby calculating the coordinates (absolute coordinates) of the annotation 734 on the second screen 73.

As described above, even if the position and size of an element in a document are changed (reflowed), an annotation having an appropriate size can be displayed at an appropriate position.

For instance, if the layout of elements on the first screen 40 has been changed (reflowed) to the layout of elements on a second screen 80 as shown in FIG. 11, where the positions and sizes of the elements in the document have been changed (reflowed), an annotation 8A on the second screen 80 corresponding to the annotation 4A on the first screen 40 is displayed at an appropriate position with an appropriate size. Further, another annotation may be added to the document with the annotation displayed on the second screen 60 shown in FIG. 5 or on the second screen 80 shown in FIG. 11. In this case, document data further including annotation data corresponding to the added annotation is stored in a storage medium.

The above-mentioned changes of the annotation display position and display size are also applicable to the reflow of elements caused by change of a window size, rotation of the screen, change of a font size, etc., during display of a document, as well as the case where the stored document is displayed on another screen having a different size.

Also, as described above, the annotation added on a document is not limited to an annotation including an image (e.g., an image shaped like a sticky note) indicating a region, and a text input via a keyboard, but may be an annotation including, for example, characters or figures handwritten on a document via the touch screen display 17.

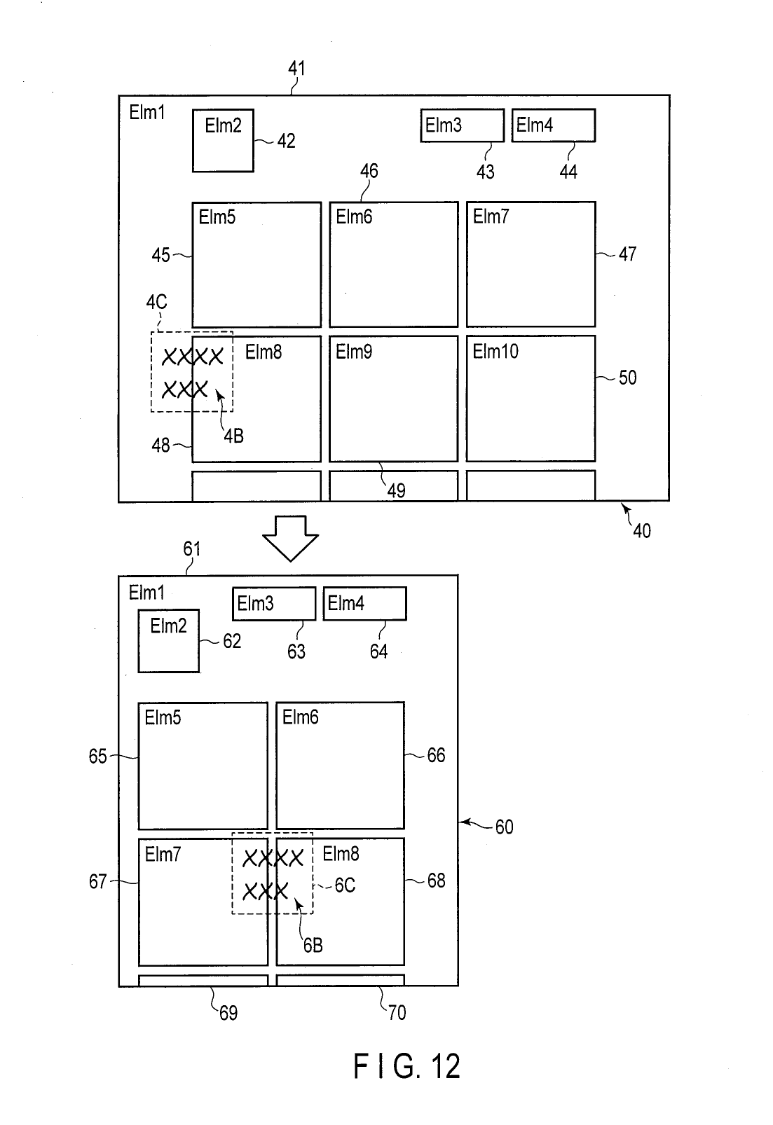

In the example of FIG. 12, it is assumed that a handwritten annotation 4B is added on a document displayed on the first screen 40. When the document including the handwritten annotation 4B is stored, the element determination module 24 determines a reference element corresponding to the annotation 4B, using the circumscribed rectangle 4C of the annotation 4B. Namely, the element determination module 24 regards the circumscribed rectangle 4C as the region of the annotation 4B, and calculates an evaluated value V representing the degree of relevance of each element 41-50 to the annotation 4B. This evaluated value V is calculated in the same way as described referring to FIG. 7.

Among the elements 41 to 50 in the document on the first screen 40, the evaluated value V of “Element 8 (Elm8)” 48 is maximum, and hence the element determination module 24 determines “Element 8” 48 as being the reference element corresponding to the annotation 4B. The element determination module 24 then detects the relative coordinates of the circumscribed rectangle 4C as the region of the annotation 4B, and stores annotation data indicating the reference element and the relative coordinates.

Further, if displaying a document on the second screen 60 differing in size from the first screen 40, the web display processor 22 determines the layout of elements 61 to 70 corresponding to the elements 41 to 50 on the first screen 40, in accordance with the size of the second screen 60. The annotation display processor 23 detects a reference element (“Element 8”) 48 corresponding to the annotation 4B, using the stored annotation data. The annotation display processor 23 then determines the position of a circumscribed rectangle 6C of an annotation 6B based on the position of a reference element 68 on the second screen 60 corresponding to the reference element 48, and also based on the relative coordinates, indicated by the annotation data, of the annotation 4B (circumscribed rectangle 4C) relative to the reference element 48.

As a result, even when the handwritten annotation 4B has been added on a document displayed on the first screen 40, an annotation 6B corresponding to the annotation 4B is displayed at an appropriate position on the second screen 60 that differs in size from the first screen 40, by the processing using the circumscribed rectangle 4C of the annotation 4B.

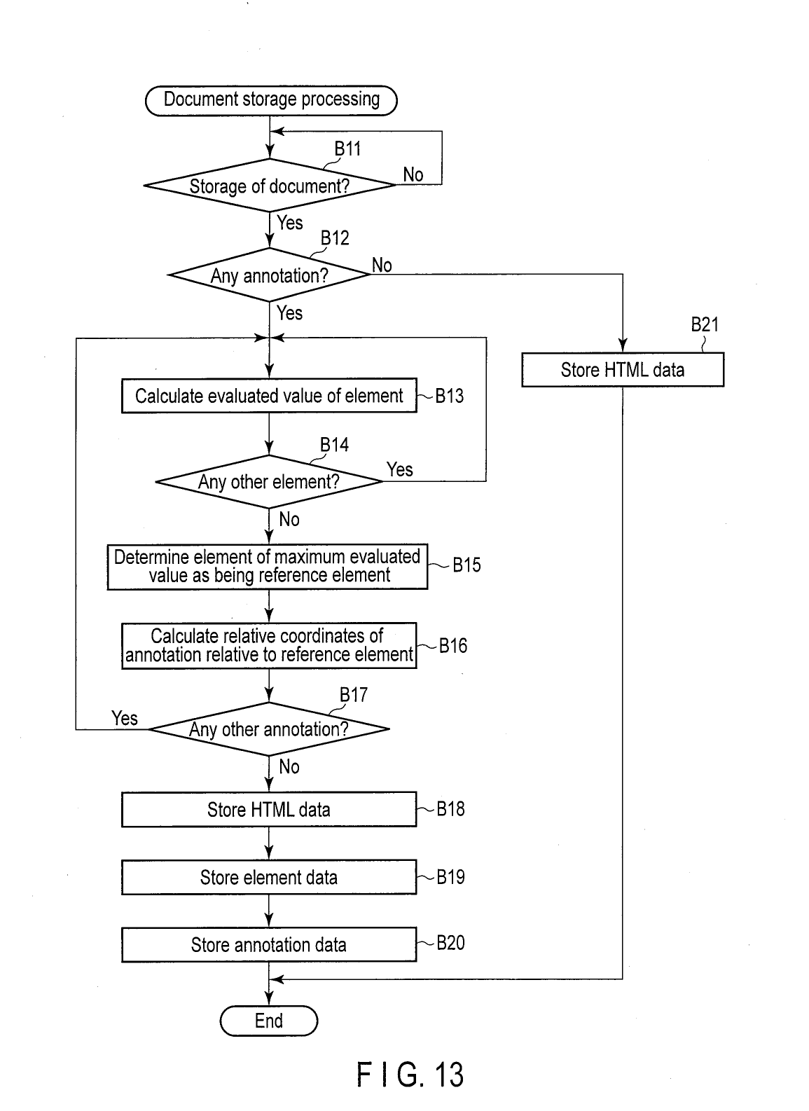

Referring then to the flowchart of FIG. 13, a description will be given of the procedure of document storage processing executed by the browser application program 202. In the description below, it is assumed that the document (e.g., a web page) is displayed on the screen of the touch screen display 17.

Firstly, the element determination module 24 determines whether storage of a document has been requested (block B11). If there is no request for document storage (No in block B11), the program returns to block B11, where it is again determined whether storage of a document has been requested.

If there is a request for document storage (Yes in block B11), it is determined whether an annotation has been made on the document (block B12). If there is no annotation on the document (No in block B12), the storage processor 25 stores the HTML data (HTML source code) of the document (block B21). This document data can be stored in an arbitrary storage medium, and is stored in, for example, the DB 13 in the client computer 10 or the DB 32A in the cloud server 32.

In contrast, if an annotation has been made on the document (Yes in block B12), the element determination module 24 calculates the evaluated value V of an element (target element) among one or more elements in the document (block B13). The evaluated value V indicates the degree of relevance of the target element to the annotation. More specifically, the element determination module 24 calculates the region (overlapping portion) E∩A in which the region E of the target element and the region A of the annotation are overlapped. Subsequently, the element determination module 24 calculates the evaluated value V of the target element based on the ratio (first ratio) of the overlapping portion E∩A to the region A of the annotation, and the ratio (second ratio) of the overlapping portion E∩A to the region E of the target element. The evaluated value V of the target element is great when both the first and second ratios are great.

After that, the element determination module 24 determines whether the document includes another element, i.e., a not yet evaluated element (block B14). If such an element remains (Yes in block B14), the program returns to block B13, where the evaluated value V of this element is calculated. Thus, the evaluated values V of all elements are calculated.

In contrast, if there is no such element (No in block B14), i.e., if the evaluated values V of all elements have been calculated, the element determination module 24 determines the element having a maximum evaluated value V as being the reference element corresponding to the annotation (block B15). Namely, the element determination module 24 determines that the element having a maximum evaluated value V is the element the user intends to link to the annotation. After that, the element determination module 24 calculates the relative coordinates (relative position) of the annotation relative to the reference element (block B16). These relative coordinates are represented using, for example, the coordinates of the upper left corner of the reference element as the origin.

Thereafter, the element determination module 24 determines whether the document contains another annotation (i.e., whether there is an annotation for which no reference element is yet determined) (block B17). If there is such an annotation (Yes in block B17), the program returns to block B13, where processing for determining the reference element corresponding to the annotation is performed.

If there is no such annotation, i.e., if the reference elements corresponding to all annotations included in the document have been determined (No in block B17), the storage processor 25 stores the HTML data of the document (block B18), and element data corresponding to all elements included in the document (block B19). The element data includes, for example, data indicating the size of each element in the displayed document. The storage processor 25 also stores annotation data corresponding to an annotation (or annotations) on the document (block B20). The annotation data includes, for example, a reference element corresponding to each annotation, the relative coordinates of each annotation relative to the corresponding reference element, the size of each annotation, the content of each annotation, etc. Document data, which includes the HTML data, the element data and the annotation data, can be stored in an arbitrary storage medium, and is stored in, for example, the DB 13 in the client computer 10 or the DB 32A in the cloud server 32.

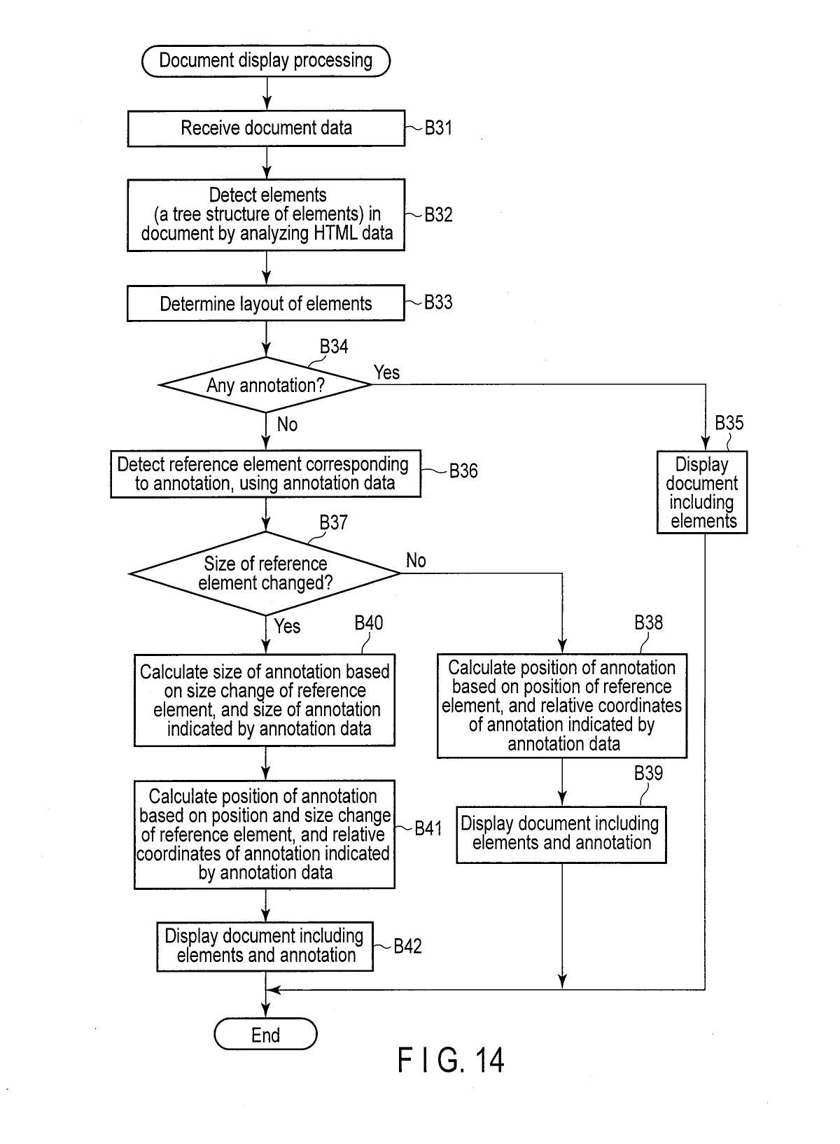

Referring now to the flowchart of FIG. 14, a description will be given of the procedure for document display processing executed by the browser application program 202. In this document display processing, it is assumed that the document stored by the document storage processing of FIG. 13 is displayed on a screen.

Firstly, the input module 21 receives document data (block B31). The input module 21 may receive the document data from the DB 32A in the cloud server 32 or read the document data from the DB 13 in the client computer 10.

The web display processor 22 subjects, to DOM analysis, the HTML source code included in the document data, to thereby detect elements (of a tree structure) included in the document (block B32). Subsequently, the web display processor 22 calculates the size and display position of each detected element to be displayed on the screen (block B33).

After that, the web display processor 22 determines whether there is an annotation on the document (block B34). For instance, the web display processor 22 determines whether an annotation exists on the document, based on whether the document data includes annotation data. If there is no annotation on the document (No in block B34), the web display processor 22 displays a document that includes elements arranged based on the determined element positions and sizes (block B35).

In contrast, if an annotation exists on the document (Yes in block B34), the annotation display processor 23 detects a reference element corresponding to the annotation, using the annotation data (block B36). After that, using element data in the document data, the annotation display processor 23 compares the size in which the reference element was displayed when the document was stored, with the size of the reference element calculated in block B33, thereby determining whether the size of the reference element has been changed (block B37).

If the size of the reference element has not been changed (No in block B37), the annotation display processor 23 calculates the annotation display position on the screen, based on the position of the reference element calculated in block B33, and the relative coordinates, indicated by the annotation data, of the annotation relative to the reference element (block B38). Subsequently, the web display processor 22 and the annotation display processor 23 display a document that includes the elements arranged at the positions in the sizes calculated in block B33, and also includes the annotation arranged at the position calculated in block B38 and in the size indicated by the annotation data (block B39).

If the size of the reference element has been changed (Yes in block B37), the annotation display processor 23 calculates the size in which the annotation is displayed on the screen, based on a change in the size of the reference element and the size of the annotation indicated by the annotation data (block B40). Namely, the region of the annotation on the screen is enlarged or reduced. Further, the annotation display processor 23 calculates the position on the screen at which the annotation is displayed, based on the position of the reference element calculated in block B33, the size change of the reference element, and the relative coordinates, indicated by the annotation data, of the annotation relative to the reference element (block B41). The web display processor 22 and the annotation display processor 23 display the document that includes the elements arranged at the positions in the sizes calculated in block B33, and also includes the annotation at the position calculated in block B41, and in the size calculated in block B40 (block B42).

Although in the above-mentioned procedure, only one annotation exists on a document, a plurality of annotations may exist on a document. In the latter case, processing for determining the display position and display size on a screen is performed for each of the annotations.

As described above, in the embodiment, an annotation (annotations) on a document can be appropriately arranged in accordance with reflow. The input module 21 receives input data of a document including a plurality of elements 41 to 50 and an annotation, wherein if the document is displayed on the first screen 40, the plurality of elements 41 to 50 is arranged in the first layout and the annotation 4A is arranged on at least a part of a first element 48 of the elements 41 to 50. The web display processor 22 and the annotation display processor 23 displays the document on the second screen 60 differing in size from the first screen 40, using the received data. If the document is displayed on the second screen 60, the plurality of elements 61 to 70 arranged in the second layout, and the annotation 6A is arranged on at least a part of a first element 68 of the elements 61 to 70 in the second layout. Therefore, even if the document displayed in the first layout on the first screen is displayed in the second layout on the second screen 60 as a result of reflow, the annotation on the document can be arranged on an appropriate element on the second screen.

All the procedures in the present embodiment, which have been described with reference to flowcharts of FIGS. 13 and 14, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various components of the systems described herein can be implemented as software applications, hardware and/or software modules, or components on one or more computers, such as servers. While the various components are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an input configured to receive input data of a document, the document comprising a plurality of elements and an annotation, wherein when the document is displayed on a first screen, the plurality of elements are in a first layout and the annotation is on at least a part of a first element of the plurality of elements; and
a display processor configured to display the document on a second screen differing in size from the first screen, using the input data, wherein when the document is displayed on the second screen, the plurality of elements are in a second layout and the annotation is on at least a part of the first element of the plurality of elements in the second layout.

2. The electronic apparatus of claim 1, wherein when the document is displayed on the second screen, the annotation is at a position relative to the first element in the second layout, and the position is based on a position of the annotation relative to the first element in the first layout.

3. The electronic apparatus of claim 1, wherein when the document is displayed on the second screen and a second size of the first element in the second layout differs from a first size of the first element in the first layout, a size of the annotation is based on a relationship between the first size and the second size.

4. The electronic apparatus of claim 1, wherein when the plurality of elements are in the first layout, the first element is determined from among the plurality of elements in accordance with a degree of relevance of each element to the annotation.

5. The electronic apparatus of claim 4, wherein when the plurality of elements are in the first layout, the degree of relevance of the first element to the annotation is determined using a degree of overlap between a region of the first element and a region of the annotation.

6. A method of display control comprising:
receiving input data of a document, the document comprising a plurality of elements and an annotation, wherein when the document is displayed on a first screen, the plurality of elements are in a first layout and the annotation is on at least a part of a first element of the plurality of elements; and
displaying the document on a second screen differing in size from the first screen, using the input data, wherein when the document is displayed on the second screen, the plurality of elements are in a second layout and the annotation is on at least a part of the first element of the plurality of elements in the second layout.

7. The method of claim 6, wherein when the document is displayed on the second screen, the annotation is at a position relative to the first element in the second layout, and the position is based on a position of the annotation relative to the first element in the first layout.

8. The method of claim 6, wherein when the document is displayed on the second screen and a second size of the first element in the second layout differs from a first size of the first element in the first layout, a size of the annotation is based on a relationship between the first size and the second size.

9. The method of claim 6, wherein when the plurality of elements are in the first layout, the first element is determined from among the plurality of elements in accordance with a degree of relevance of each element to the annotation.

10. The method of claim 9, wherein when the plurality of elements are in the first layout, the degree of relevance of the first element to the annotation is determined using a degree of overlap between a region of the first element and a region of the annotation.

11. A computer-readable, non-transitory storage medium having stored thereon a program for display control which is executable by a computer, the program controlling the computer to execute functions of:
receiving input data of a document, the document comprising a plurality of elements and an annotation, wherein when the document is displayed on a first screen, the plurality of elements are in a first layout and the annotation is on at least a part of a first element of the plurality of elements; and
displaying the document on a second screen differing in size from the first screen, using the input data, wherein when the document is displayed on the second screen, the plurality of elements are in a second layout and the annotation is on at least a part of the first element of the plurality of elements in the second layout.

12. The storage medium of claim 11, wherein when the document is displayed on the second screen, the annotation is at a position relative to the first element in the second layout, and the position is based on a position of the annotation relative to the first element in the first layout.

13. The storage medium of claim 11, wherein when the document is displayed on the second screen and a second size of the first element in the second layout differs from a first size of the first element in the first layout, a size of the annotation is based on a relationship between the first size and the second size.

14. The storage medium of claim 11, wherein when the plurality of elements are in the first layout, the first element is determined from among the plurality of elements in accordance with a degree of relevance of each element to the annotation.

15. The storage medium of claim 14, wherein when the plurality of elements are in the first layout, the degree of relevance of the first element to the annotation is determined using a degree of overlap between a region of the first element and a region of the annotation.
